(19) United States
(12) Patent Application Publication
(10) Pub. No.: US 2019/0372328 A1
(43) Pub. Date: Dec. 5, 2019

(54) CABLE BUSHING HAVING SHIELDING AND SEALING PROPERTIES

(71) Applicant: ICOTEK PROJECT GMBH & CO. KG, Mogglingen (DE)

(72) Inventors: Bruno Ehmann, Mogglingen (DE); Valentin Ehmann, Schwabisch Gmund (DE)

(21) Appl. No.: 16/480,204

(22) PCT Filed: Jan. 24, 2018
(86) PCT No.: PCT/EP2018/051643

§ 371 Date: Jul. 23, 2019

(30) Foreign Application Priority Data
Jan. 25, 2017 (DE) 10 2017 000 654.7
Jun. 2, 2017 (DE) 10 2017 209 368.4

(51) Int. Cl. H02G 15/013; H02G 3/22; H02G 3/06

(52) U.S. Cl. CPC H02G 15/013; H02G 3/065; H02G 3/22

(57) ABSTRACT

The invention relates to a cable bushing with shielding and sealing properties for connection to a wall having an opening, said cable bushing comprising a sealing element and a shielding element in which, in turn, one or more cables can be received in perforations and/or penetration zones.

The cable bushing according to the invention is characterized in that the sealing element and the shielding element are formed from an elastomer as a one-piece, at least partially electrically conductive receiving element for the at least one cable.

### CROSS-REFERENCE TO RELATED APPLICATION

The present application is a National Stage of International Application No. PCT/EP2018/051643, filed Jan. 24, 2018, and which claims priority to DE 10 2017 000 654.7, filed Jan. 25, 2017 and DE 10 2017 209 368.4, filed Jun. 2, 2017, the entire disclosures of which are hereby expressly incorporated herein by reference

The disclosure relates to a cable bushing with shielding and sealing properties.

### BACKGROUND/SUMMARY

According to the general prior art, special EMC cable glands are used for inserting cables in a waterproof and dust-proof manner, for example into a switch cabinet, with strain relief and for protection against electromagnetic waves. The screw-in housing thereof is made of a conductive material, usually nickel-plated brass. The seal against water and dust works in a conventional manner by way of a sealing ring. To implement the electromagnetic shielding, the electrically conductive cable shield is usually contacted by a plurality of spring leaves in a region of the cable in which said cable is stripped of the outer layer of the insulation, wherein the voids between the individual spring leaves are not covered. The conductive shield is thus interrupted at these locations. Electromagnetic waves can penetrate at these locations.

The generic prior art in the form of DE 103 56 386 B3 describes such a cable bushing with a double nipple made of electrically conductive material and a pressure screw which can be screwed onto said nipple and has an axial through-opening. Inserted between the pressure screw and the double nipple is a sealing element, through which the cable is passed via a perforation or a penetrable region. Further inside the double nipple, the cable is then stripped for a short distance in the axial direction of the cable and is electrically contacted in this region by a disc made of conductive material, for example conductive plastic or metal. Unlike the contacting by way of the spring leaves according to the abovementioned prior art, therefore, a contact is established which covers the entire cross-section of the cable bushing and thus has no gaps through which electromagnetic waves can penetrate. The problem is the relatively complex structure, which requires sealing in the region of the sealing element on the one hand and reliable contacting in the region of the cable shield on the other hand. The structure described in the generic prior art is thus complicated to manufacture and install.

In order to meet the increasing demands in the industrial networking of components with simultaneously increasing demands on electromagnetic compatibility (EMC) and thus on the quality of shielding, a simple and less expensive solution must be sought. This is not made possible by the structures according to the prior art. The cost-effective solution must comprise an insertion of cables in combination with protection against dust/water. In addition, strain relief and shielding against electromagnetic waves is necessary. In order to achieve all this, according to the prior art a large number of individual elements are required. This makes it very expensive and complicated to manufacture and install conventional EMC cable glands, in particular also due to the need to use different materials for the individual components.

The problem addressed by the present disclosure is to remedy this problem and to specify a cable bushing according to the preamble of claim 1 which is extremely easy to manufacture and install and which can be produced very inexpensively.

According to the disclosure, this problem is solved by a cable bushing having the features in claim 1. Advantageous embodiments and developments will emerge from the claims dependent thereon.

Conventionally, the protection against water/dust and the shielding against electromagnetic waves are separated from one another. Either in the manner described above via a sealing ring made of elastomer to protect against water/dust and for strain relief and also metal springs for implementing the electromagnetic shielding, in which the cable shield is contacted. This structure is substantially likewise found in the generic prior art, wherein in this case, instead of the metal springs, use is made of an element made of a conductive material, for example a plastic, in addition to the sealing element. The solution according to the disclosure now combines all the requirements of protection against dust/water with the strain relief and the shielding against electromagnetic waves in one single component, namely the at least partially electrically conductive receiving element made of an elastomer.

In the simplest variant of the receiving element, the latter has just one perforation or one penetration zone for each of the intended cables. By forming the one-piece, at least partially electrically conductive receiving element from elastomer, it is possible to considerably reduce the size of the through-opening for electromagnetic waves and thus to considerably restrict the frequency range of electromagnetic waves that can penetrate through the structure. No contacting of the electrically conductive cable shield beneath the outer insulation/sheath of the cable is necessary. Instead, the reduction in size of the through-opening, namely to an annular gap in the thickness of the outer electrical insulation of the cable, is sufficient to shield against interference up to a frequency of around 10 GHz. The structure is extremely simple and can be sealed very tightly, in particular also due to the fact that the cable need not be stripped in places, so that insufficient sealing inside the cable itself, that is to say for example beneath the outer insulation along the electrically conductive cable shield, can be reliably prevented.

Another advantage is that the at least partially electrically conductive receiving element, as an elastic sealing element, adapts to the adjoining components and thus forms an ideal shield against electromagnetic waves. Even when using different cable diameters of the cables, adaptation to the respective cable diameters can take place on the same sealing element due to the elastomer. This makes the receiving element extremely efficient and flexible to install in practice.

One disadvantage of this very simple embodiment variant it is that interference occurring on the cable shield itself cannot be dissipated and can run along the cable shielding or the cable shield through the cable bushing.

The cable may therefore also be stripped for a portion of its axial length, so that here the electrically conductive cable shield is exposed. If the cable is then inserted into the receiving element in such a way that a part of the cable sheath, that is to say the outer insulation of the cable, bears against the receiving element and the stripped section directly adjacent thereto, then both a seal at the cable sheath and a contacting at the cable shield can be achieved due to the elasticity of the elastomer. However, the cable must be positioned very precisely in the axial direction during installation.

According to one highly advantageous development of the concept, it may therefore be provided that the perforation or penetration zone has two different internal diameters, one behind the other in the axial direction of the cable, which are designed to bear against the insulation of the cable on the one hand and to bear against a stripped portion of the cable, in which the conductive cable shield is exposed, on the other hand. In this case, preferably a perforation or a penetration zone is configured in such a way that it has two different diameters which directly follow one another in a stepped manner. A cable, which is stripped of its outer insulation in one portion so that the electrically conductive cable shield is exposed in this region, is then inserted into the perforation or penetration zone. The region with the slightly larger diameter comes to bear against the outer insulation of the cable, and the portion with the smaller diameter comes to bear against the electrically conductive cable shield. The receiving element then serves both for strain relief and for sealing, in a manner analogous to the embodiment variant described above, and additionally for electrically dissipating interference on the cable shield in the region in which the receiving element contacts the cable shield. As a result, even interference running along the cable shield is efficiently shielded.

The structure requires a relatively precise adaptation of the perforation or the penetration zone to the expected cable. This may also prove to be a disadvantage in practice. Another highly advantageous embodiment of this concept therefore provides that each of the perforations or penetration zones is formed by two regions of the receiving element which are spaced apart in the axial direction of the cable, with a cavity located therebetween. The structure is thus in fact formed by two, or possibly even more, membranes made of the elastomer which are located one behind the other. This allows a very secure and reliable seal on the outer insulation of the cable on the one hand and a very reliable contacting of the stripped portion of the electrically conductive cable shield of the cable on the other hand. The structure can be manufactured extremely inexpensively and efficiently and can be installed very easily.

The cavity between the two membranes located one behind the other, for sealing against the outer insulation of the cable, that is to say the cable sheath, increases the elasticity of the elastomer even further so that, even with very different diameters of cables, secure sealing and reliable shielding is achieved together with strain relief on the cable due to the friction fit between the receiving element and the outer cable sheath.

The receiving element may be directly connected to the wall having the opening. Said wall is usually part of an electrically conductive housing around the electronics connected to the cable, in particular the wall of a switch cabinet. The elastic receiving element may for example have an outer circumferential groove, via which it can be connected to the wall in such a way that it is elastically deformed upon insertion in the opening so that, after the receiving element has returned to the initial state, the wall around the opening comes to lie in the groove. Alternatively, it is also conceivable that, according to one advantageous development of the concept, an electrically conductive frame or a screw-in housing is formed around the one-piece receiving element. Such an electrically conductive frame or a screw-in housing, which may also be formed in multiple parts, then sealingly accommodates the receiving element. The frame or the screw-in housing is then connected, for example screwed, to the wall around the opening. The electrically conductive frame or the electrically conductive screw-in housing may be made of different materials. For instance, metals are conceivable on the one hand, but in particular also electrically conductive plastics, in particular fibre-reinforced electrically conductive plastics.

The at least partially electrically conductive elastomer of the receiving element is a specially designed elastomer with electrical or partially electrically conductive properties or may preferably be an elastomer which contains conductive additives, in order to reliably achieve on the one hand the shielding and on the other hand the sealing and strain relief in the one-piece receiving element.

Another extremely advantageous embodiment additionally provides that the receiving element has a perforation or a plurality of perforations which are connected to the outer circumference of the receiving element via one or more slits. Such a structure, in which the perforation is provided directly within the receiving element, may provide that said perforation is provided with a slit which connects the perforation, or if the slit is suitably arranged optionally also a plurality of perforations, to the outer circumference of the receiving element by way of a slit. In the case of a receiving element having a plurality of perforations, a plurality of slits may also be provided. The receiving element can then suitably open up as the cable is being inserted into the perforation. This has the advantage that even pre-fabricated cables, that is to say cables which already carry plugs at their ends, can easily and efficiently be inserted into the receiving element, without requiring the plug to be removed in advance and then refitted. When installing such a slit receiving element in the opening or, according to the advantageous embodiment described above, in the electrically conductive frame or the screw-in housing and with the latter on the wall around the opening, the slits in the elastomer are then pressed against one another and sealingly closed under sufficient pressure.

Further advantageous embodiments of the cable bushing according to the disclosure will also emerge from the exemplary embodiments which are described in greater detail below with reference to the figures.

### BRIEF DESCRIPTION OF THE DRAWINGS

In the figures:

FIG. 1 shows a conventional EMC cable bushing according to the prior art;

FIG. 2 shows a cable bushing according to the disclosure in a first possible embodiment;

FIG. 3 shows a cable bushing according to the disclosure in a second possible embodiment;

FIG. 4 shows a cable bushing according to the disclosure in a third possible embodiment; and

FIG. 5 shows a cable bushing according to the disclosure in a fourth possible embodiment;

FIG. 6 shows a cable bushing according to the disclosure in a fifth possible embodiment.

### DETAILED DESCRIPTION

The diagram of FIG. 1 shows a conventional cable bushing, which is also referred to as an EMC cable gland, according to the prior art. This has a screw-in housing 1 which consists for example of a double nipple 7 and a pressure screw 8. Inserted between the double nipple 7 and the pressure screw 8 is an electrically conductive intermediate piece having spring leaves 10 which are provided for contacting an electrically conductive cable shield 4 of a cable 13. As can be seen at the left-hand end of the diagram in FIG. 1, the cable 13 itself may consist of one or more conductive wires 11 which are surrounded by an inner insulation 12. The latter is in turn surrounded by the electrically conductive cable shield 4, which in turn is surrounded by a cable sheath 3 as outer insulation. Besides this electrical contacting of the cable shield 4 for shielding purposes, a sealing element 14 is provided inside the pressure screw 8 for sealing the structure against dust/water and for achieving strain relief for the cable 13. The entire structure can then be inserted in an opening of a wall 19, for example the wall 19 of an electrically conductive housing or switch cabinet, in a manner sealed by way of the double nipple 7, for example by way of the indicated O-ring seal 16, and clampingly screwed to the wall 19 by way of a screw 20 in the region of the double nipple 7. The contacting via the spring leaves 10 enables only a conductive shield, but the latter is interrupted multiple times around the circumference so that electromagnetic waves can penetrate at these locations.

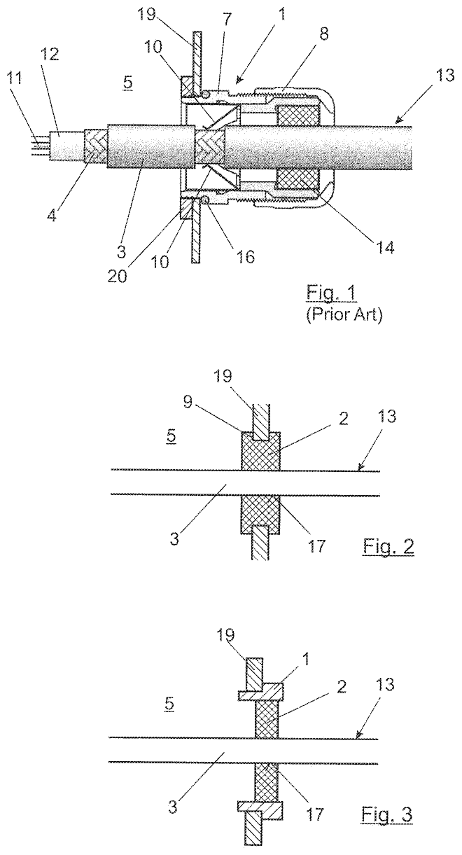

The simplest embodiment variant of the disclosure is shown in the diagram of FIG. 2. A one-piece and integral receiving element 2 performs the function of sealing, strain relief and shielding. The receiving element 2 is at least partially electrically conductive and is formed from elastomer and receives, in a perforation 17, the cable 13 along its cable sheath 3, that is to say the outer insulation. For installation purposes, the receiving element 2 itself is elastically deformed in the opening of the wall 19 of the switch cabinet and, once it has returned to its initial shape, then receives the wall 19 in a circumferential groove 9.

FIG. 3 shows a comparable structure. The only difference here is that the receiving element 2 is accommodated in an illustrated screw-in housing 1, similar to the structure according to the prior art in FIG. 1.

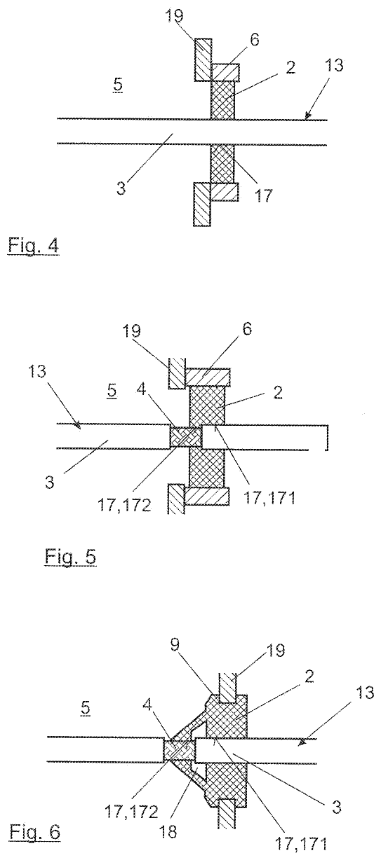

FIG. 4 shows a further comparable structure. The only difference here is that the receiving element 2 is accommodated in a frame 6. If the receiving element covers at least approximately the entire opening, the frame 6 need not necessarily be electrically conductive, but it may be.

In this simplest variant of the cable bushing shown in FIGS. 2 to 4, there is no electrical contacting of the cable shield 4 in the cable 3, said cable shield 4 not being shown here but nevertheless being present. Instead, it is a case of relying on the fact that electrically conductive materials are present over the entire cross-section, with the exception of the annular gaps of the cable insulations. These annular gaps are typically so small that shielding up to around 10 GHz is possible without any problem. Only for interference already located on the electrically conductive cable shield 4 may shielding not be achieved, but rather said interference will run through the cable bushing in this embodiment variant shown in FIGS. 2 to 4 into the illustrated interior 5 of the switch cabinet.

The diagram of FIG. 5 shows an alternative embodiment. Instead of the screw-in housing 1 or the groove 9 as the connection between the receiving element 2 and the wall 19, a frame 6 is again provided here in a manner analogous to the diagram in FIG. 4, which frame is connected to the wall, for example by screwing, but should now be preferably electrically conductive. Here, the perforation 17 in the receiving element 2 has a first diameter 171 and a second diameter 172. The two diameters 171 and 172 of the perforation 17 are adapted to one another in such a way that, in the region of the diameter 171, the receiving element 2 bears against the cable sheath 3 of the cable 13 in a manner sealed against water and dust. On the other hand, in the region of the diameter 172, which is slightly smaller, typically in the order of magnitude of around 2 mm relative to the diameter, the receiving element bears against the cable shield 4 of the cable 13, which is again exposed here in a manner analogous to the diagram in FIG. 1. In addition to the shielding of field-bound electromagnetic waves, which attempt to penetrate through the wall 19 via the opening which is closed by the receiving element 2 in the frame 6, the interference already located on the cable shield 4 can thus also be dissipated. The shielding is therefore improved. The strain relief and the sealing against water and dust can be achieved via a higher contact pressure. At the same time, the reliable contacting of the cable shield 4 can also be achieved, so that the interior 5 of a switch cabinet for example is ideally protected by way of the receiving element 2.

Given sufficient elasticity of the elastomer of the receiving element 2, it is also conceivable to configure the perforation 17 with a constant diameter during manufacture, so that the two different diameters for bearing against the cable sheath 3 on the one hand and the cable shield 4 on the other hand are achieved as a result of the elasticity of the elastomer only at the time of insertion or after insertion of the cable 13 into the receiving element 2.

The diagram of FIG. 6 shows a further variant. In a manner analogous to the embodiment shown in FIG. 2, the wall 19 around the opening is connected to the receiving element 2 with a form fit. This shows in the axial direction of the cable 13 a perforation 17 having a first diameter 171 which surrounds the cable sheath 3 sealingly and with strain relief. Said perforation 17 is followed by a type of cavity 18 or a correspondingly larger diameter of the perforation. This is then followed by a further part of the perforation 17 having a smaller diameter 172 in the manner of a membrane. Upon insertion of the cable 13, said membrane closes around a stripped part of the cable 13, in which the electrically conductive cable shield 4 is exposed, and thus contacts the receiving element 2 with the latter. As a result, the conductive wall 19 of the switch cabinet is also contacted with the cable shield 4 via the receiving element 2. This provides ideal sealing and shielding while allowing very easy installation. The structure can in particular be used to shield the interior (denoted 5 in the diagrams of the figures) of a switch cabinet (not shown) on the one hand and to reliably seal it against dust and water on the other hand.

According to one highly advantageous development of the concept according to the disclosure, the at least partially electrically conductive elastomer of the receiving element may consist of an elastomer which is conductive per se or of an elastomer which contains conductive additives. A sufficient conductivity for the electromagnetic shielding is achieved as a result.

According to an alternative highly advantageous development of the cable bushing according to the disclosure, it may also be provided that the at least partially electrically conductive elastomer of the receiving element is produced from an electrically non-conductive elastomer which has an electrically conductive surface coating. Of course, the structures could also be combined, so that an electrically conductive elastomer could additionally carry a conductive surface coating.

The frame 6 and the screw-in housing 1 may also be made of an electrically conductive plastic or may be provided with an electrically conductive surface coating in a manner analogous to the receiving element. Alternatively, of course, structures of the screw-in housing and of the frame which are made of previously customary materials, for example metals such as in particular nickel-plated brass, are also conceivable.

The different variants for connecting the wall 19 to the receiving element 2, via the groove 9, the frame 6 or the screw-in housing 1, can of course be combined at will with any variant of the receiving element 2 in FIGS. 2 to 6.

1. Cable bushing with shielding and sealing properties for connection to a wall having an opening, said cable bushing comprising a sealing element and a shielding element in which, in turn, one or more cables can be received in perforations and/or penetration zones,
wherein
the sealing element and the shielding element are formed from an elastomer as a one-piece, at least partially electrically conductive receiving element for the at least one cable.

2. Cable bushing according to claim 1, wherein the one-piece, at least partially electrically conductive receiving element is formed from an elastomer which has an electrical conductivity due to additives.

3. Cable bushing according to claim 1, wherein the one-piece, at least partially electrically conductive receiving element is formed from an elastomer which has an electrically conductive surface coating.

4. Cable bushing according to claim 1, wherein the perforations or penetration zones are designed to bear against the outer insulation or the cable sheath of the cable.

5. Cable bushing according to claim 1, wherein the perforations or penetration zones have two different internal diameters which are designed to bear against the outer insulation or the cable sheath of the cable on the one hand and to bear against a stripped portion of the cable, in which the electrically conductive cable shield is exposed, on the other hand.

6. Cable bushing according to claim 1, wherein each of the perforations or each of the penetration zones is formed by two regions of the receiving element which are spaced apart in the axial direction of the cable, with a cavity located therebetween.

7. Cable bushing according to claim 1, wherein the receiving element is accommodated in an electrically conductive screw-in housing or frame which is designed to be electrically conductively connected to the wall around the opening.

8. Cable bushing according to claim 7, wherein the electrically conductive frame or the electrically conductive screw-in housing is formed from an electrically conductive plastic.

9. Cable bushing according to claim 1, wherein the receiving element has one or more perforations which are connected to the outer circumference of the receiving element via one or more slits.

10. Cable bushing according to claim 1, wherein the receiving element has a circumferential groove along its outer circumference.

11. Cable bushing according to claim 2, wherein the perforations or penetration zones are designed to bear against the outer insulation or the cable sheath of the cable.

12. Cable bushing according to claim 3, wherein the perforations or penetration zones are designed to bear against the outer insulation or the cable sheath of the cable.

13. Cable bushing according to claim 2, wherein the perforations or penetration zones have two different internal diameters which are designed to bear against the outer insulation or the cable sheath of the cable on the one hand and to bear against a stripped portion of the cable , in which the electrically conductive cable shield is exposed, on the other hand.

14. Cable bushing according to claim 3, wherein the perforations or penetration zones have two different internal diameters which are designed to bear against the outer insulation or the cable sheath of the cable on the one hand and to bear against a stripped portion of the cable, in which the electrically conductive cable shield is exposed, on the other hand.

15. Cable bushing according to claim 2, wherein each of the perforations or each of the penetration zones is formed by two regions of the receiving element which are spaced apart in the axial direction of the cable, with a cavity located therebetween.

16. Cable bushing according to claim 3, wherein each of the perforations or each of the penetration zones is formed by two regions of the receiving element which are spaced apart in the axial direction of the cable, with a cavity located therebetween.

17. Cable bushing according to claim 4, wherein each of the perforations or each of the penetration zones is formed by two regions of the receiving element which are spaced apart in the axial direction of the cable, with a cavity located therebetween.

18. Cable bushing according to claim 5, wherein each of the perforations or each of the penetration zones is formed by two regions of the receiving element which are spaced apart in the axial direction of the cable, with a cavity located therebetween.

19. Cable bushing according to claim 2, wherein the receiving element is accommodated in an electrically conductive screw-in housing or frame which is designed to be electrically conductively connected to the wall around the opening.

20. Cable bushing according to claim 3, wherein the receiving element is accommodated in an electrically conductive screw-in housing or frame which is designed to be electrically conductively connected to the wall around the opening.
